(19) United States
(12) Patent Application Publication
(10) Pub. No.: US 2019/0034417 A1
(43) Pub. Date: Jan. 31, 2019

(54) METHOD FOR ANALYZING DIGITAL CONTENTS

(71) Applicant: RESEARCH COOPERATION FOUNDATION OF YEUNGNAM UNIVERSITY, Gyeongsangbuk-do (KR)

(72) Inventors: Byung Won On, Jeollabuk-do (KR); Gyu Sang Choi, Daegu (KR); Hyun Kwang Shin, Gyeongsangbuk-do (KR)

(21) Appl. No.: 16/080,891

(22) PCT Filed: Jan. 15, 2018
(86) PCT No.: PCT/KR2018/000653

§ 371 Date: Aug. 29, 2018

(30) Foreign Application Priority Data
Jan. 13, 2017 (KR) 10-2017-0006408

(51) Int. Cl. G06F 17/27; G06F 17/18; G06F 17/30; G06Q 30/02; G06Q 50/00

(52) U.S. Cl. CPC G06F 17/2785; G06F 17/18; G06F 17/2775; G06Q 30/0201; G06Q 50/01; G06F 17/30598

(57) ABSTRACT

A method for analyzing digital contents is disclosed. According to an embodiment, a plurality of information sources are extracted from digital contents associated with a specific topic, an information source network is created on the basis of the plurality of information sources, and at least one of quantitative and qualitative analyses for the corresponding topic is performed on the basis of the information source network.

### CROSS REFERENCE TO RELATED APPLICATIONS

This application is a national stage application, filed under 35 U.S.C. § 371, of International Application No. PCT/KR2018/000653, filed Jan. 15, 2018, which international application claims priority to South Korean Application No. 10-2017-0006408, filed Jan. 13, 2017, the contents of both of which as are hereby incorporated by reference in their entirety.

BACKGROUND

### Technical Field

Example embodiments relate to a digital content analyzing method and are applicable to fields of, for example, surveying, marketing, information retrieval, text mining, and big data.

### Description of Related Art

In order for an organization or an enterprise to start work, public opinions or customer opinions may be investigated in advance. Most of the survey work may be performed by a survey agency. In general, the survey agency may conduct a survey by performing a telephone or visit survey, collecting results, and making reports.

“With the proliferation of mobile devices, people are not cooperating with polls, and polling information is more difficult than ever to predict the future,” said Gallup President Jim Clifton, who participated in the 2016 Asian Leadership Conference. He also said “data collected through polling is hard to trust, and existing data is not worth it. It's up to Gallup in the future to use big data technology to analyze data and discover new meanings or solutions.” For example, most of the media in the United States, including the New York Times and the Washington Post, predicted that Presidential candidate Hillary Clinton would be elected in the 45^{th} US presidential election. But unlike many other media predictions, Donald Trump was elected president of the United States. This means that the traditional method of conducting the survey and analyzing the results by the researchers is significantly less efficient. The traditional methods have the following disadvantages. First, existing traditional methods may require high costs for researchers and statistical experts. Second, even with the same subject, different results may be obtained due to a difference of items in a questionnaire. Third, a subjective judgment of a respondent may be reflected. Also, when the survey response rate and sample size are insufficient, there will be a lot of distortions in estimating a population, so that reliable results may not be obtained. When using a human investigation method, it is difficult to obtain results in a short period of time.

### BRIEF SUMMARY

Example embodiments provide technology for analyzing a polarity of controversial news articles. In addition, example embodiments provide technology for automatically summarizing topics of controversial news articles. Also, example embodiments provide technology for automatically deriving a survey result through a data analysis and automatically summarizing the survey result.

Example embodiments are applicable to various digital contents including news articles and contents posted on a social network.

According to an aspect, there is provided a method of analyzing digital content, the method including receiving a keyword corresponding to a predetermined subject, collecting digital content associated with the subject based on the keyword, extracting, from the digital content, a plurality of opinions related to the subject and a plurality of information sources providing the plurality of opinions, generating a network based on the plurality of information sources, performing at least one of a quantitative analysis and a qualitative analysis on the subject based on the network, and providing an analysis result.

The extracting of the plurality of information sources may include extracting an information source from words adjacent to a predetermined punctuation mark when the digital content is a news article.

The extracting of the plurality of information sources may include extracting a commenter creator as an information source when the digital content is content posted on a social network.

The generating of the network may include configuring the extracted information sources as nodes and connecting nodes corresponding to information sources extracted from the same digital content.

To perform the quantitative analysis, the performing may include classifying polarities of the plurality of opinions into positive, neutral, and negative, calculating weights of the plurality of information sources based on the network, and calculating quantitative statistics of positive opinions and negative opinions about the subject based on a result of the classifying and the weights.

The calculating of the quantitative statistics may include calculating, for each of the plurality of information sources, scores of the plurality of information sources based on a polarity of opinions of the corresponding information source and a weight of the corresponding information source, and calculating the quantitative statics based on the scores of the plurality of information sources.

To perform the qualitative analysis, the performing may include detecting time-chronological main stories associated with the subject based on a plurality of subgraphs included in the network, and extracting a representative sentence neutrally describing each of the main stories, a representative positive opinion about the subject, and a representative negative opinion about the subject.

The extracting of the main stories may include collecting, for each of the subgraphs, digital content including at least one information source in the corresponding subgraph, performing an unsupervised clustering on the digital content including the at least one information source based on a content similarity and a time similarity, and determining each of clusters generated as a result of the clustering to be a main story.

The extracting of the representative sentence may include selecting, for each of the main stories, latest digital content from digital contents included in the corresponding main story, extracting the representative sentence from the latest digital content based on a first reference associated with a neutral sentence characteristic, a second reference associated with a sentence title similarity, and a third reference associated with a sentence location, extracting a most influential information source having a positive polarity and a most influential information source having a negative polarity from information sources of the corresponding main story, and extracting opinions of the extracted most influential information sources.

According to example embodiment, it is possible to overcome an inaccurate result of a survey conducted by researchers. Also, instead of conducting a survey by hand, a proposed algorithm may automatically collect and analyze data on the web so that a flow of objective opinions is accurately acquired.

According to example embodiment, it is possible to reduce costs since a survey is carried out without an assistance of researchers and statistic experts. In addition, a time required to conduct the survey may be significantly reduced. Also, the entire contents and details of a corresponding subject such as a time, opinion leaders, and main arguments may be automatically extracted.

### BRIEF DESCRIPTION OF THE FIGURES

FIG. 1(a), FIG. 1(b), FIG. 1(c), and FIG. 1(d) are diagrams illustrating an information source network according to an example embodiment.

FIG. 2(a), FIG. 2(b), and FIG. 2(c) are diagrams illustrating an operation of estimating a positive ratio and a negative ratio using a baseline method according to an example embodiment.

FIG. 3 is a diagram illustrating an operation of estimating a positive ratio and a negative ratio with respect to a controversial subject based on an influence of an information source according to an example embodiment.

FIG. 4 is a diagram illustrating a method of detecting a main story according to an example embodiment.

FIG. 5 is a diagram illustrating a story-aware clustering method according to an example embodiment.

FIG. 6 is a diagram illustrating a summarization of a main story according to an example embodiment.

### DETAILED DESCRIPTION OF VARIOUS EMBODIMENTS

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments will be described in detail with reference to the accompanying drawings. Like numbers refer to like elements throughout.

Generation of Information Source Network Associated with Controversial Subject

In an example embodiment, digital content associated with a predetermined subject may be retrieved from the entire digital contents. The entire digital contents may be provided in advance or in real time through a network. The digital content may include, for example, a news article and contents posted on a social network. The predetermined subject may be a controversial subject about which a positive opinion and a negative opinion are in conflict. Hereinafter, for brevity of description, the digital content may be the news article.

When news articles related to a controversial subject c are retrieved from the entire news articles D, a set of news articles including the controversial subject c may be expressed as D(c)→{n₁,n₂,n₃, . . . ,nₘ}. A news article nᵢ may be an i^{th} news article including the controversial subject c. For example, a keyword corresponding to the controversial subject c may be input as a search query in a search portal. In this example, a news article related to the controversial subject c may be collected based on the keyword.

In an example embodiment, an information source network may be generated by extracting information sources included in the set D(c). The information source may be a source of information that expresses a positive, neutral, or negative opinion about a controversial subject. Also, the information source may be, for example, a natural person with professional knowledge or business experience related to the corresponding subject. When the digital content is the news article, the information source may be a news information source. When the digital content is the content posted on the social network, the information source may be a comment creator. The information source network may be a graph generated based on the source of information that expresses an opinion about the controversial subject. As described below, the information source may include a plurality of sub-graphs.

To extract the information sources from the set D(c), sentences such as {l₁,l₂,l₃, . . . ,lₘ} having a predetermined punctuation mark, for example, a pair of double quotation marks may be detected from the news article nᵢ satisfying nᵢ∈{n₁,n₂,n₃, . . . ,nₘ}. The detected sentences may be a plurality of opinions related to the controversial subject c.

The information source may be detected based on words positioned before and/or after the predetermined punctuation mark, for example, a pair of double quotation marks. For example, a name of the news information source may be extracted based on nouns positioned before and/or after the pair of double quotation marks. To generate the information source network, news information sources may be expressed as nodes. A label of a node may be expressed by the name of the corresponding news information source. Each of the nodes may include information on a quotation. When news information sources x and y are included in the same news article nᵢ, nodes x and y may be connected to each other. Such process may be performed on all news information sources, so that the information source network related to the controversial subject c is generated.

TABLE 1

| Term | Description |
|---|---|
| Art_idList | List contains unique news article. |
| dList | Each record of list contains information on news article |
| | ID, title, contents, and direct quotations. |
| sList | List contains news information source and direct |
| | quotation. |
| uList | List contains unique name of news information source. |
| Ru | Each record of list contains information on news |
| | information source, connection degree centrality, |
| | number of positive polarities, and number of negative |
| | polarities. |
| ArticleList | List contains news articles including a specic query |
| gapList | List contains time gaps between news articles |
| simList | List contains the similarity value between news articles |
| rAList | List contains clustered news articles |

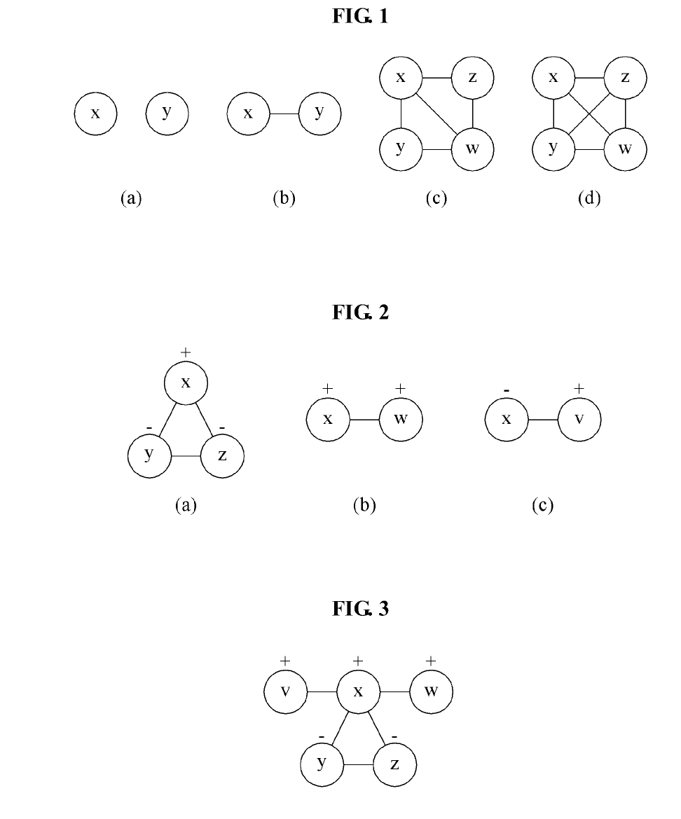

FIG. 1(a), FIG. 1(b), FIG. 1(c), and FIG. 1(d) are diagrams illustrating an information source network according to an example embodiment. Referring to FIG. 1(a), two individual nodes may indicate that the information sources x and y are quoted in different news articles. Referring to FIG. 1(b), two nodes may be connected to each other, which may indicate that the information sources x and y are quoted in the same news article nᵢ.

Referring to FIG. 1(c), the information sources x and y and an information source w may be quoted in the news article nᵢ and the information sources x and z and an information source z may be quoted in a news article nⱼ. In this example, the information sources x and w may be simultaneously quoted in the news articles nᵢ and nⱼ, and the information source network may be generated based on the information sources x and w. Referring to FIG. 1(d), all information sources may be quoted in the news article nᵢ and the information sources may be associated with one another.

Algorithm 1 may be a pseudo-code that generates an information source network associated with a controversial subject.

Algorithm 1. News information source network generation

```
  1: C={c₁, c₂, ..., cₙ};
  2: G={g₁, g₂, ..., gₙ};
  3: for id ∈ Art idList do
  4:  for d ∈ dList do // d is a record
  5:  if id == d.art_id then
  6:  cᵢ ← d.name;
  7:  end if
  8:  end for
  9:  i++;
10: end for
11: for c ∈ C do
12:  for cNext ∈ C do
13:  if c.name ∩ cNext.name then
14:  gᵢ ← c ∪ cNext;
15:  end if
16:  end for
17: end for
```

Although not shown, when the digital content is content posted on a social network, information sources and opinions may be extracted based on comments of the corresponding content. For example, contents about the controversial subject may be collected and users having generated comments may be extracted as information sources. The extracted information sources may be configured as nodes. Also, nodes of information sources having generated comments for the same content may be connected to one another.

Polarity Analysis on Controversial Subject

In an example embodiment, a polarity analysis on a controversial subject may be performed. Through the polarity analysis, a quantitative analysis may be performed on the controversial subject. To estimate a positive ratio and a negative ratio with respect to the controversial subject, two methods may be suggested as follows.

Method 1: baseline method used to estimate positive ratio and negative ratio with respect to controversial subject

Method 1 is “a method of classifying, to estimate a positive ratio and a negative ratio, quotations of information sources in an information source network into a positive quotation and a negative quotation through a sentiment analysis and counting a number of positive quotations and a number of negative quotations for all quotations.” For example, the sentiment analysis may be performed to estimate the positive ratio and the negative ratio with respect to the controversial subject. The sentiment analysis may be performed by measuring information on polarities including positive, neutral, and negative from a text. The news information source x and a direct quotation q of the information sources may be expressed as a pair, for example, (x, {q₁,q₂,q₃, . . . ,qₖ}). The quotation q may be used as salient information for determining the polarity of a sentiment. The sentiment analysis may also be referred to as SA(*). The sentiment analysis SA(*) may be expressed as SA(qᵢ)→[+|0|−] in which + represents positive, 0 represents neutral, and − represents negative.

A direct quotation of the news information source x may be, for example, {q₁,q₂,q₃,q₄}. Also, a sentiment analysis result of each quotation may be, for example, SAₓ(q₁)→+, SAₓ(q₂)→+, SAₓ(q₃)→0, SAₓ(q₄)→−. In this example, the information source x may have two positive polarities, one neutral polarity, and one negative polarity.

A baseline method may be a method of performing the sentiment analysis on all quotations and counting polarities. Through this, a number of news information sources in favor of the controversial subject c may be estimated. Likewise, a number of news information sources opposing the controversial subject c may be also estimated.

The baseline method may estimate a positive ratio and a negative ratio of the controversial subject c using Equations 1 and 2.

$$\begin{matrix}Pros ratio ( c ) = \frac{{\sum }_{i = 1}^{n} \{ 1 \vert SA ( {q}_{i} ) = + \}}{{\sum }_{i = 1}^{n} \{ 1 \vert SA ( {q}_{i} ) = + SA ( {q}_{i} ) = - \}} & [ Equation 1 ] \\ Cons ratio ( c ) = \frac{{\sum }_{i = 1}^{n} \{ 1 \vert SA ( {q}_{i} ) = - \}}{{\sum }_{i = 1}^{n} \{ 1 \vert SA ( {q}_{i} ) = + SA ( {q}_{i} ) = - \}} & [ Equation 2 ]\end{matrix}$$

In Equations 1 and 2, a sum of positive opinions and negative opinions may be divided by a number of positive opinions and a number of negative opinions to obtain the positive ratio and the negative ratio of the controversial subject c. Algorithm 2 may be a pseudo-code associated with the baseline method of estimating the positive ratio and the negative ratio of the controversial subject c.

Algorithm 2.
Method 1: Estimation of positive ratio and
negative ratio of controversial subject

| | |
|---|---|
| 1: | for s ∈ SList do |
| 2: | if s.sentiment == pos then |
| 3: | p_valu++: |
| 4: | end if |
| 5: | else |
| 6: | n_value++; |
| 7: | end else |
| 8: | end for |
| 9: | $Pros ratio ← \frac{p\_value}{p\_value + n\_value} ;$ |
| 10: | $Cons ratio ← \frac{n\_value}{p\_value + n\_value} ;$ |

FIG. 2(a), FIG. 2(b), and FIG. 2(c) are diagrams illustrating an operation of estimating a positive ratio and a negative ratio using a baseline method according to an example embodiment. Referring to FIG. 2(a), information sources x, y, and z may be quoted in a first news article related to a controversial subject c, the information source x may be in favor of the controversial subject c, and the information sources y and z may oppose the controversial subject c. Referring to FIG. 2(b), the information source x and an information source w may be quoted in a second news article related to the controversial subject c, the information source x may be in favor of the controversial subject c, and the information source w may oppose the controversial subject c. Referring to FIG. 2(c), the information source x and an information source v may be quoted in a third news article related to the controversial subject c, the information source x may oppose the controversial subject c, and the information source v may be in favor of the controversial subject c.

In this example, a number of positive polarities may be 4 and a number of negative polarities may be 3. According to Equations 1 and 2, a positive ratio may be calculated to be 0.57(=4/(4+3)) and a negative ratio may be calculated to be 0.43(=3/(4+3)).

Method 2: estimating positive ratio and negative ratio with respect to controversial subject based on influence of information source

Method 2 is “a method of estimating a positive ratio and a negative ratio of a predetermined subject based on an influence of a news information source in addition to Method 1.” To enhance the aforementioned Method 1, an influence G of a news information source related to the controversial subject c may be considered.

In Method 2, it is assumed that a news information source having a high influence on the controversial subject c is more important than a new information source having a low influence on the controversial subject c. When the news information source x has a number of neighbors including the information sources y, . . . , z and the new information source has a neighbor that is an information source p, the information source x may be quoted in more news articles than the information source y and have a higher influence on the controversial subject in comparison to the information source y. For example, When the information source x speaks unilaterally on a subject such as abortion, the information source x may be called an opinion leader as a representative of supporters or opponents. However, the information y has only one interview and thus, may not be the representative of supporters or opponents.

Influences G of opinion leaders on the controversial subject c may be determined based on a connection degree centrality of nodes. A value of the connection degree centrality of a node vₓ corresponding to the news information x may be determined based on a number of nodes directly connected to the node vₓ. In an example embodiment, a positive ratio and a negative ratio may be obtained by assigning a weight to a new information source influential in the controversial subject c. Equation 2 is an equation for obtaining a score PA_{C}(x) for each information source based on the weight.

$${PA}_{c} ( x ) = ω \times \frac{max ( {\sum }_{i = 1}^{n} \{ 1 \vert {SA}_{x} ( {q}_{i} ) = + \} , {\sum }_{i = 1}^{n} \{ 1 \vert {SA}_{x} ( {q}_{i} ) = - \} )}{{\sum }_{i = 1}^{n} \{ 1 \vert {SA}_{x} ( {q}_{i} ) = + {SA}_{x} ( {q}_{i} ) = - \}} \qquad [ Equation 3 ]$$

Here, w denotes a weight of the information source x and indicates how much influence the information source x has on the controversial subject c. The weight w may be determined based on a value of the connection degree centrality of the information source x and calculated using

$$\frac{{C}_{D} ( x )}{\{ {C}_{D} ( i ) arg {max}_{i} {C}_{D} ( i ) \}} .$$

In this case, the positive ratio and the negative ratio may be estimated using Equations 4 and 5.

$$\begin{matrix}Pros ratio ( c ) = \frac{{\sum }_{i = 1}^{n} \{ 1 \vert {PA}_{c} ( {x}_{i} ) \vert {x}_{i} \to + \}}{{\sum }_{i = 1}^{n} \{ {PA}_{c} ( {x}_{i} ) \vert {x}_{i} \to + \} + {\sum }_{i = 1}^{n} \{ {PA}_{c} ( {x}_{i} ) \vert {x}_{i} \to - \}} & [ Equation 4 ] \\ Cons ratio ( c ) = \frac{{\sum }_{i = 1}^{n} \{ 1 \vert {PA}_{c} ( {x}_{i} ) \vert {x}_{i} \to - \}}{{\sum }_{i = 1}^{n} \{ {PA}_{c} ( {x}_{i} ) \vert {x}_{i} \to + \} + {\sum }_{i = 1}^{n} \{ {PA}_{c} ( {x}_{i} ) \vert {x}_{i} \to - \}} & [ Equation 5 ]\end{matrix}$$

FIG. 3 is a diagram illustrating an operation of estimating a positive ratio and a negative ratio with respect to a controversial subject based on an influence of an information source according to an example embodiment. Referring to FIG. 3, a news information source x may have a greatest connection degree centrality. The connection degree centrality of the news information source x may be 4.

Referring to FIG. 2(a), FIG. 2(b), and FIG. 2(c), the information source x may have two positive polarities and one negative polarity. Between a positive group and a negative group, a group having a greater number of polarities may be determined to be a representative polarity of the information source x. In the example of FIG. 3, the information source x may be classified as the positive polarity. In this example, when a score of the information source x is calculated using Equation 3, a score PA_{C}(x) of the information source x may be calculated to be

$$0.66 ( = \frac{4}{4} \times \frac{2}{( 2 + 1 )} )$$

Information sources v and w may be classified as the positive polarity and scores PA_{C}(v) and PA_{C}(w) may be calculated to be

$$0.25 ( = \frac{1}{4} \times \frac{1}{1} )$$

Information sources y and z may be classified as the negative polarity and scores PA_{C}(y) and PA_{C}(z) may be calculated to be

$$0.5 ( = \frac{2}{4} \times \frac{1}{1} )$$

A sum of the positive polarities, for example,

$${\sum }_{i = 1}^{n} \{ {PA}_{c} ( {x}_{i} ) \vert {x}_{i} \to + \}$$

may be calculated to be 1.16. A sum of the negative polarities, for example,

$${\sum }_{i = 1}^{n} \{ {PA}_{c} ( {x}_{i} ) \vert {x}_{i} \to - \}$$

may be calculated to be 1. When a positive ratio and a negative ratio of the controversial subject c is estimated, the positive ratio, for example,

$$Pros ratio ( c ) = \frac{1.16}{( 1.16 + 0.5 )}$$

may be calculated to be 0.69 and the negative ratio, for example,

$$Cons ratio ( c ) = \frac{1.16}{( 1.16 + 0.5 )}$$

may be calculated to be 0.31.

Algorithm 3 may be a pseudo-code for estimating the positive ratio and the negative ratio based on Method 2.

Algorithm 3.
Method 2: Estimation of positive ratio and
negative ratio of controversial subject

| | |
|---|---|
| 1: | for u ∈ uList do |
| 2: | for s ∈ E sList do |
| 3: | if u == s.name then |
| 4: | deg ← (deg+d.degree); |
| 5: | if s.sentiment == pos then |
| 6: | p_value++; |
| 7: | end if |
| 8: | else |
| 9: | n_value++; |
| 10: | end else |
| 11: | end if |
| 12: | end for |
| 13: | Ru.name ← d.name; |
| 14: | Ru.degree ← deg; |
| 15: | Ru.sentiment ← {p_value, n_value}; |
| 16: | deg ← 0; |
| 17: | p_value ← 0; |
| 18: | n_value ← 0; |
| 19: | end for |
| 20: | maxd=max(Ru.degree); |
| 21: | for r ∈ Ru do |
| 22: | {p_cnt, n_cnt} ← r.sentiment; |
| 23: | max_value ← max(p_cnt, n_cnt); |
| 24: | $score ← \frac{max\_value}{p\_cnt + n\_cnt} \times \frac{r \cdot degree}{maxd} ;$ |
| 25: | if p_cnt > n_cnt then |
| 26: | p_score ← p_score+score; |
| 27: | end if |
| 28: | else |
| 29: | n_score ← n_score+score; |
| 30: | end else |
| 31: | end for |
| 32: | $Pros ratio ← \frac{p\_score}{p\_score + n\_score} ;$ |
| 33: | $Cons ratio ← \frac{n\_score}{n\_score + n\_score} ;$ |

In an example embodiment, a qualitative analysis may be performed on a controversial subject. The qualitative analysis may include detection and summarization of a main story as described below.

Detection of Main Story about Controversial Subject

In general, influential news information sources may present opinions about the controversial subject c over a long period of time. An information source network may include one or more stories. In the news media, when an event occurs, similar contents about the controversial subject c may be generated in a predetermined period of time, or news articles of various events related to the controversial subject c may be generated.

In an example embodiment, to detect a main story about the controversial subject c, a similarity between the news articles and a time difference may be considered. For example, the news information source x may be associated with the news information sources y, z, and w, and an influence of the information source x may be G. Relationships between the news information source x and the other new information sources may be represented as (x, y), (x, z), and (x, w).

The relationship (x, y) may be configured as a news article n₁ that delivers a story s₁ in a time tₐ, the relationship (x, z) may be configured as a news article n₂ that delivers a story s₂ in a time t_{b}, and the relationship (x, w) may be configured as a news article n₃ that delivers a story s₃ in a time t_{c}. In the time tₐ and the time t_{b}, when a value of a similarity between the news articles n₁ and n₂ is greater than a threshold, for example, sim(n₁,n₂)≥θ, the news articles n₁ and n₂ may deliver the same story.

In an example embodiment, an unsupervised clustering method may be used. For example, a cohesive clustering algorithm that merges closest objects into a single cluster using Equation 6 may be proposed. The proposed algorithm may also be referred to as “a story-aware clustering method.”

$$sim ( {n}_{i} , {n}_{j} ) = α \times ( 1 - \frac{{\sum }_{i = 1}^{n} {vn}_{i} ( i ) {vn}_{j} ( i )}{\sqrt{{\sum }_{i = 1}^{n} {{vn}_{i} ( i )}^{2}} \sqrt{{\sum }_{j = 1}^{n} {{vn}_{j} ( j )}^{2}}} ) + ( 1 - α ) \times \frac{Gap ( t ( {n}_{i} ) , t ( {n}_{j} ) )}{max ( Gap ( t ( {n}_{i} ) , t ( {n}_{j} ) ) )} \qquad [ Equation 6 ]$$

Here, vnᵢ denotes a feature vector of the news article nᵢ. A set of unique words may be generated based on sentences included in the news articles nᵢ and nⱼ. Each of the words may be one feature or dimension. For example, when a number of the words is 100, vnᵢ may be a feature vector including 100 features. If vnᵢ(i)=1, vnᵢ(i) may indicate a word matching an i^{th} feature of the feature vector vnᵢ of the news article nᵢ, and 0 otherwise.

The story-aware clustering method may start with each vector in its own set of objects. Two most similar clusters may be merged in each operation. When a single cluster of all the vectors is generated, a subsequent operation may be performed. When clustering is performed for all news articles, an appropriate level of dendrogram may be determined.

As a result, a clustering set including various stories about the controversial subject c may be acquired. For example, contents of the news articles n₁, n₂, and n₃ may be as follow.

n₁:

Gosnell gets third life sentence for babies during late-term abortions (2013 May 16)

Dr. Kermit Gosnell, convicted in Philadelphia of killing newborns after late-term abortions, thanked his judge and lawyer after his final sentencing Wednesday.

n₂:

Lawyers give closing arguments in abortion doctor's trial (2013 June 30):

Lawyers gave their final arguments Monday in the trial of Kermit Gosnell, the Philadelphia doctor charged with the murder of babies born live after abortions.

n₃:

Protests mark return of Texas Legislature to consider abortion bill (2013 Jul. 05):

The Texas Legislature reconvened in a special session Monday to reconsider an abortion bill Senate Republicans failed to pass last week.

A similarity between the news articles may be defined as, for example, f₁(nᵢ, nⱼ). Also, a time difference between the news articles may be defined as, for example, f₂(nᵢ, nⱼ). The similarity between the news articles may be 1-similarity between articles. For example, f₁(n₁, n₂)=0.12, f₁(n₁, n₃)=0.36, and f₁(n₂, n₃)=0.3.

To consider the time difference between the news articles, a date of each of the news articles may be converted into an epoch time. Time differences between the news articles may be, for example, f₂(n₁, n₂)=3715200, f₂(n₁, n₃)=9417600, and f₂(n₂, n₃)=5702400. The time differences may be normalized based on a maximum time difference. In this example, f₂(n₁, n₂)=0.16, f₂(n₁, n₃)=0.4, and f₂(n₂, n₃)=0.24.

When Algorithm 4 based on Equation 6 is performed, h₁={n₁, n₂} and h₂={n₃} may be obtained. For example, {n₁, n₂} included in h₁ may cover “a murder trial against an abortion physician in Philadelphia” and “the final argument by a Philadelphia physician.” Also, {n₃} included in h₂ may include “reclamation of the Texas legislature in a special session on Monday for the abortion bill.” Each cluster may have one story.

When it is clustered to include a plurality of news articles as in h₁, only one latest news article may be extracted. Algorithm 4 may be a pseudo-code of the story-aware clustering method.

Algorithm 4.
Story-aware clustering method

| | |
|---|---|
| 1: | for a ∈ ArticleList do |
| 2: | for aNext ∈ ArticleList do |
| 3: | simList ← (1−cosine_similarity(a.art, aNext.art))×w; |
| 4: | gapList ← \|d−dNext\|; |
| 5: | end for |
| 6: | end for |
| 7: | for g ∈ gapList do |
| 8: | $data ← ( \frac{g}{max ( gapList )} \times ( 1 - w ) ) + simList . \geq t ( i ) ;$ |
| 9: | i++; |
| 10: | end for |
| 11: | H ← AverageLinkage(th, distList); |

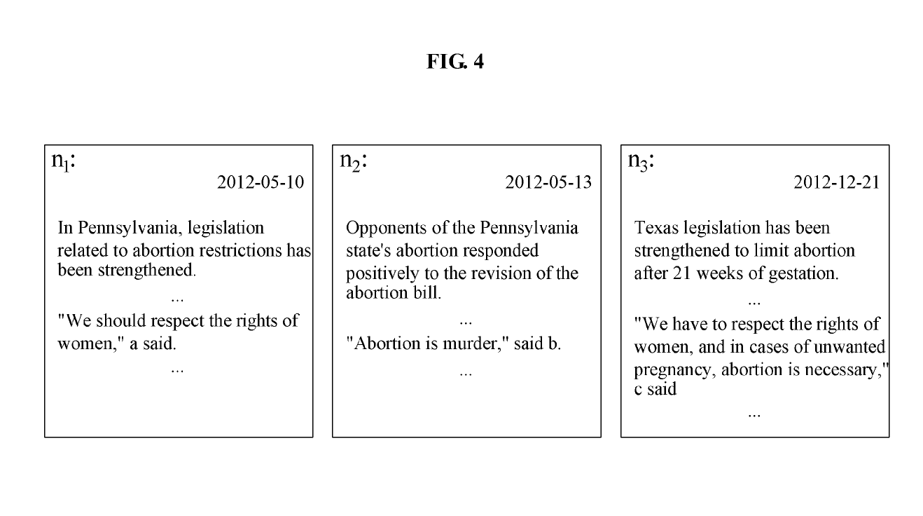

FIG. 4 is a diagram illustrating a method of detecting a main story according to an example embodiment. Referring to FIG. 4, news articles n₁, n₂, and n₃ may be related to an abortion. Specifically, the news article n₁ may be about the Pennsylvania's abortion restriction bill and an information source a of the news article n₁ is in favor of the abortion. The news article n₂ may be about the Pennsylvania's abortion restriction bill and an information source b of the news article n₂ may oppose the abortion. The news article n₃ may be about the Texas's abortion restriction bill and an information source c of the news article n₃ may be in favor of the abortion.

The news articles n₁and n₂ may include quotations for different positions but cover the same content about the Pennsylvania's abortion restriction bill. Thus, the news articles n₁ and n₂ may be classified as the same story. The news articles n₁ and n₃ may include quotations for the same position but covers contents about abortion restriction bills of different states. Also, a time difference may be at most seven months. Thus, the news articles n₁ and n₃ may be classified as different stories.

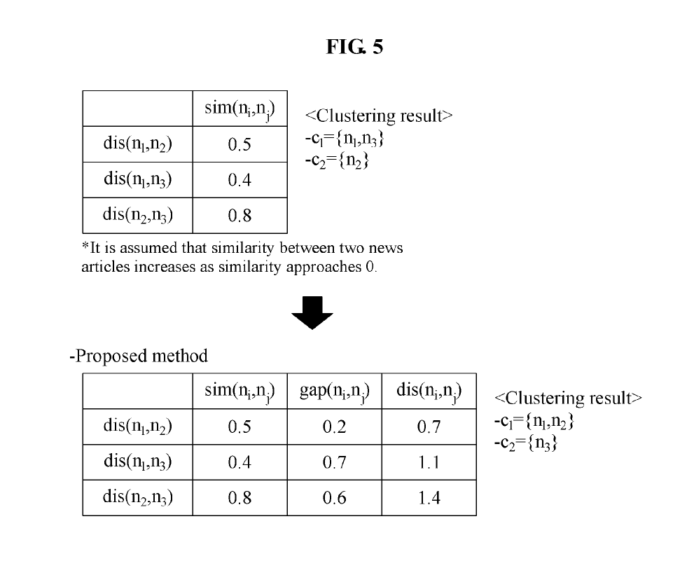

FIG. 5 is a diagram illustrating a story-aware clustering method according to an example embodiment. sim(nᵢ, nⱼ) may be a content similarity between news articles and gap(nᵢ, nⱼ) may be s time difference between the news articles. sim(nᵢ, nⱼ) may decrease as the similarity between the news articles increases and gap(nᵢ, nⱼ) may decrease as the time difference between the news articles decreases.

Also, dis(nᵢ, nⱼ) may be a distance between the news articles and clustering may be performed based on the distance between the news articles. For example, as dis(nᵢ, nⱼ) decreases, a probability of the news articles being classified as the same cluster may increase.

Referring to FIG. 5, when the content similarity between the news articles is considered, news articles n₁ and n₃ may be classified into one cluster. As in the proposed method, when the similarity between the news articles and the time difference between the news articles are considered, the news articles n₁ and n₂ may be classified into one cluster.

Summarization of Main Story about Controversial Subject

Main stories about a controversial subject c may be stored in a link list L. The link list L may be a list of nodes, each including a data field and a link field. In this example, information on the news articles may be sorted by the latest new article. Each data field may include items as follows.
Representative sentence: a sentence that is neutral and covers overall contents in a news article related to a controversial subject
Positive group: quotations of opinion leaders supporting the controversial subject
Negative group: quotations of opinion leaders opposing the controversial subject

When hᵢ is given based on the story-aware clustering method, all news articles of hᵢ may include a set of sentences, for example, {l₁,l₂, . . . ,lₖ}. The representative sentence may be extracted using Equation 7.

$$score ( {l}_{i} ) = {w}_{f} {\sum }_{j = 1}^{n} {w}_{j} {f}_{j} ( {l}_{i} ) = {w}_{g} {\sum }_{j = 1}^{m} {w}_{j} {g}_{j} ( {l}_{i} ) + {w}_{h} h ( {l}_{i} ) \qquad [ Equation 7 ]$$

Here, w_{f}+w_{g}+wₕ=1. Also, f( ) denotes a function linearly combined based on fact information. Fact words of the news article may be more salient than other words and may not be associated with sentimental meaning. The function f( ) may be based on a date, a place, an institution or organization, a percentage, a number, a neural sentiment score, and a combination thereof. When a sentence lᵢ includes at least one noun related to a date, a place, an institution, a percentage, and a number, values of f₁(lᵢ), . . . , f₅(lᵢ) may be 1 and 0 otherwise. The neutral sentiment score f₆(lᵢ) may be calculated using

$$\frac{Number of neutral words of {l}_{i}}{Number of neutral words in news article {n}_{i}} .$$

The function f( ) may be calculated by linearly combining scores of the aforementioned six features.

g( ) may be a function that measures a similarity between a title of the news article nᵢ and the sentence lᵢ. The representative sentence may be similar to a title of a news article and may be to provide more information than the title. From the title and the sentence lᵢ, stopwords may be removed and a stemmer may be considered. Here, the stopwords may be index words such as an article, a preposition, and a conjunction, which may be meaningless. A stem may be extracted using a stemmer method. For example, a stem “mat” may be extracted from a word “matting.

Three factors may be considered in the function g( ). A predefined syntactic similarity measure such as

$$\frac{\vert A ⋂ B \vert}{\vert A ⋃ B \vert}$$

may be used, A∪B being a union between a set of words included in the sentence lᵢ and a set of words included in the title of the news article and A∩B being an intersection between the two sets of words. In addition, a semantic similarity may be measured to solve a semantic ambiguity of words. For example, “cost” and “price” are synonyms. As such, the synonyms between the title and the sentence lᵢ may be considered. Also, location and date information may be considered to improve a current semantic similarity. The current semantic similarity may be measured using, for example,

$$\frac{\vert A ⋂ B \vert}{\vert A ⋃ B \vert} \times \frac{{f}_{location} ( {l}_{i} ) + {f}_{date} ( {l}_{i} )}{2} .$$

h( ) may be considered. In the news article, sentences at a predetermined location, for example, a few sentences at a head portion) may include overall contents. Thus, serial numbers may be assigned to sentences of the news article. The news article n₁ may include three sentences l₁, l₂, and l₃, for example, a first sentence, a second sentence, and a third sentence. In this example, the sentences may have serial numbers 1, 2, and 3, respectively. An importance of a sentence location may be calculated using

$$h ( {l}_{i} ) = 1 - \frac{log ( {nl}_{i} )}{log ( L )}$$

based on locations of the sentences, L being a total number of sentences included in the news articles nᵢ and nlᵢ being a serial number corresponding to each of the sentences.

To calculate a value of score(lᵢ) using Equation 7, parameter values of w_{f}, w_{g}, and wₕ may be adjusted through an experiment.

Also, in the news article nᵢ, quotations representing positive and negative opinions may be summarized with a core sentence. For this, a connection degree centrality or a parameter centrality may be measured and the quotations of the positive and negative opinions may be presented in the news article nᵢ. For example, a news article about the abortion may be provided as shown below.

Lawyers give closing arguments in abortion doctor's trial

Lawyers gave their final arguments Monday in the trial of Kermit Gosnell, the Philadelphia doctor charged with the murder of babies born live after abortions. Deliberations were expected to begin Tuesday after instructions to the jury from Common Pleas Judge Jerey Mineheart, The Philadelphia Inquirer reported.

A title and contents of the news article may be divided in units of sentences, and then stopwords may be removed from each of the sentences (l₁={Lawyers final arguments Monday trial Kermit Gosnell Philadelphia doctor charged murder babies born live abortions}, l₂={Deliberations expected begin Tuesday instructions jury Common Pleas Judge Jerey Philadelphia Inquirer reported}, . . . ). Thereafter, a representative sentence may be extracted based on features such as a fact, an event, and location information.
a) Fact information extraction: a region, an institution, and a date may be tagged to each of the sentences (l₁={Lawyers final arguments <DATE>Monday trial Kermit Gosnell <LOCATION>Philadelphia doctor charged murder babies born live abortions}, l₂={Deliberations expected begin <DATE>Tuesday instructions jury <ORGANIZATION>Common Pleas Judge Jerey Philadelphia Inquirer reported}, . . . ).

Tag information, for example, <DATE> and <LOCATION> included in the sentence lᵢ may be verified. Since the sentence lᵢ includes two tags <DATE> and <LOCATION>, f₁(l₁)=1, f₂(l₁)=1, and f₃(l₁)=f₄(l₁)=f₅(l₁)=0. In terms of the sentence l₂, f₁(l₁)=1, f₃(l₁)=1, and f₂(l₁)=f₄(l₁)=f₅(l₁)=0.

In addition, a sentiment analysis may be performed on all words included in the sentences to consider a neutral word. For example, 50 words may be neural among all of the words. When the sentence l₁ includes 15 neutral words, f₆(l₁)=15/50. When the sentence l₂ includes 11 neutral words, f₆(l₂)=11/50.

The function f( ) may be calculated using

$${w}_{f} {\sum }_{j = 1}^{n} {w}_{j} {f}_{j} ( {l}_{i} ) .$$

For example, f(l₁) may be 0.63(=(0.3×1)+(0.3×1)+(0.1×0.3)) and f(l₂) may be 0.422(=(0.3×1)+(0.1×1)+(0.1×0.22)). Likewise, other sentences may also be calculated.
b) Event information extraction: a stopword removal and the stemmer method may be performed on the title and the contents of the news article, and a similarity between the title and the sentence lᵢ may be measured. The title of the news article may be {Lawyers close argument abort doctor trial}. The contents of the news article may include l₁={Lawyers nal argument Mondai trial Kermit Gosnell Philadelphia doctor charg murder babi born live abort} and l₂={Deliber expect begin Tuesdai instruct juri Common Plea Judg Jerei Philadelphia Inquirer report}.
Syntactic similarity: since (the title of the news article ∪ the sentence lᵢ)=16 and (the title of the news article ∩ the sentence lᵢ)=5, a similarity value of the first sentence may be calculated to be 0.3125(=5/16). Likewise, a similarity value of the second sentence may be calculated to be 0 (=0/20). A Jaccard similarity value may be used as the similarity value.
Semantic similarity: when synonyms is considered with respect to each of the words, a similarity value between the title and the first sentence may be 0.4769 and a similarity value between the title and the second sentence may be 0.033. When the function g( ) is calculated using

$${\sum }_{j = 1}^{m} {w}_{j} {g}_{j} ( {l}_{i} ) ,$$

g(l₁) may be 0.3783(=(0.3×0.3125)+(0.3×0.3125)+(0.4×0.4769)) and g(l₂) may be 0.3783(=(0.3×0)+(0.3×0)+(0.4×0.033)).
Syntactic similarity based on place and date: a syntactic similarity value, a place, and a data may be considered. The first sentence includes the place and the data and thus, calculated to be 0.3125 using

$$0.3125 \times \frac{( 1 + 1 )}{2} .$$

The second sentence may be calculated to be 0 using

$$0 \times \frac{( 1 + 0 )}{2} .$$

c) Location information calculation: a serial number may be assigned to each sentence. For example, serial numbers 1, 2, . . . , k may be assigned to the sentences, l₁, l₂, . . . , lₖ. Also, an importance of each sentence location may be considered using

$$h ( {l}_{i} ) = 1 - \frac{log ( {ln}_{i} )}{log ( L )}$$

in which h(l₁) may be 1 and h(l₂) may be 0.699.

Through this, one representative sentence having a highest score may be extracted using Equation 7.

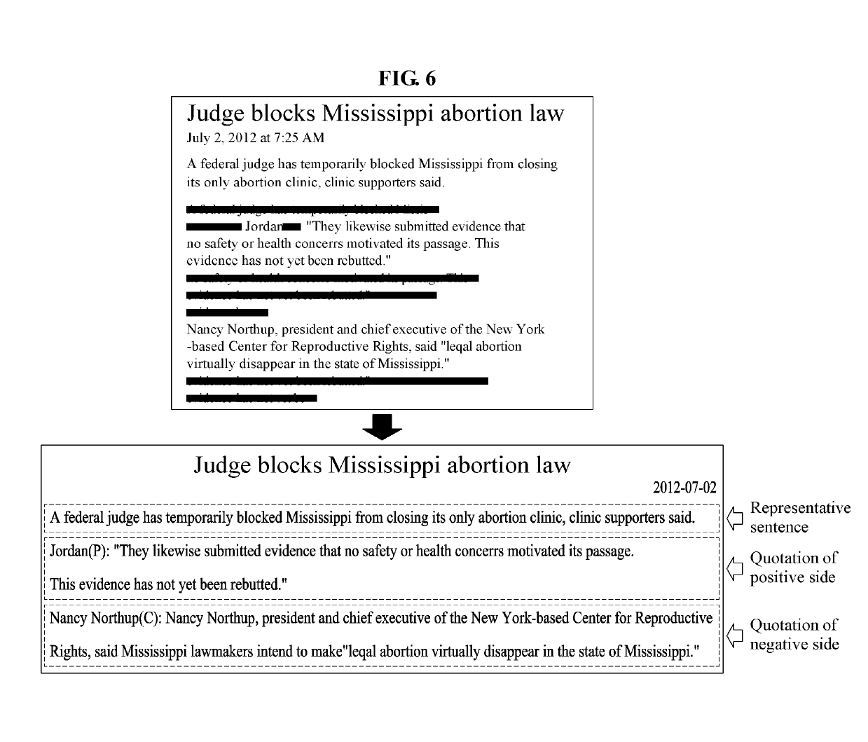

FIG. 6 is a diagram illustrating a summarization of a main story according to an example embodiment. Referring to FIG. 6, a representative sentence, a positive opinion leader, a positive quotation, a negative opinion leader, and a negative quotation may be automatically extracted from a news article.

Algorithm 4 may be a pseudo-code for detecting a main story about a controversial subject.

Algorithm 4.
Main story detection method

| | |
|---|---|
| 1: | for ra ∈ rAList do |
| 2: | s_list ← sentence_extract(ra): |
| 3: | aw_list ← word_split(ra): |
| 4: | asent_list ← sentiment(aw_list); |
| 5: | for a ∈ asent_list do |
| 6: | if a == neu then |
| 7: | neu_total++; |
| 8: | end if |
| 9: | end for |
| 10: | for s ∈ s_list do |
| 11: | s_tag ← sentence tag(s): |
| 12: | if <Location> ∈ s_tag then |
| 13: | L ← 1; |
| 14: | end if |
| 15: | else if <Organization> ∈ s_tag |
| 16: | O ← 1: |
| 17: | end else if |
| 18: | else if <Date> ∈ s_tag then |
| 19: | D ← 1: |
| 20: | end else if |
| 21: | else if <Percent> ∈ s_tag then |
| 22: | P ← 1; |
| 23: | end else if |
| 24: | else if <Number> ∈ s_tag then |
| 25: | N ← 1; |
| 26: | end else if |
| 27: | word_list ← word split(s); |
| 28: | sent list ← sentiment(word_list); |
| 29: | for s ∈ sent_list do |
| 30: | if s = = neu then |
| 31: | neu_value++; |
| 32: | end if |
| 33: | end for |
| 34: | $n ← \frac{neu\_value}{neu\_total} ;$ |
| 35: | fact ← (L×f₁)+(O×f₂)+(D×f₃)+(P×f₄)+(N×f₅)+(n×f₆); |
| 36: | title_wordList ← word_split(title.get(index)); |
| 37: | $Jaccard ← \frac{word\_list ⋂ title\_wordList}{word\_list ⋃ title\_wordList} ;$ |
| 38: | $Jaccard\_fact ← Jaccard \times \frac{L + D}{2} ;$ |
| 39: | wordnet ← wordNet(title.get(index), s); |
| 40: | trigger ← (Jaccard+t₁)+(Jaccard_fact+t₂)+(wordNet+t₃); |
| 41: | no++; |
| 42: | $position ← 1 - \frac{log ( no )}{s\_list . size ( )} ;$ |
| 43: | Result ← (w_{f}×fact)+(w_{g}×trigger)+(wₕ×position); |
| 44: | end for |
| 45: | index++; |
| 46: | end for |

As described above, to overcome limitations of typical surveys, embodiments may collect news articles from web sites, analyze the news articles, and provide a positive ratio and a negative ratio with respect to a controversial subject. In this example, a summary of the news articles may also be provided such that users acquires meaningful information.

When a controversial subject, for example, the abortion or an illegal immigration is input, the embodiments may collect news articles related to the subject. Thereafter, the news articles may be qualified by a positive ratio and a negative ratio with respect to the controversial subject. Based on the positive ratio and the negative ratio, meaningful information on the subject may be easily acquired. For example, when a positive ratio and a negative ratio with respect to a controversial subject t₁ are 51%:49%, the controversial subject t₁ may be one of social issues on which positive opinions and negative opinions are seriously confronted and thus, need to be solved urgently for social integration. Also, a positive ratio and a negative ratio with respect to a controversial subject t₂ are 75%:25%. It can be known from that most people are in favor of the controversial subject t₂, and thus the controversial subject t₂ may be one of the problems that need not be solved urgently. Interestingly, with respect to some topics, a positive ratio and a negative ratio may change over time, and the positive ratio and the negative ratio may differ for each region or country.

Embodiments may chronologically extract interesting stories related to a controversial subject. To detect the interesting stories about the controversial subject, a story-aware clustering method is proposed.

Embodiments may summarize news articles about the controversial subject to visually provide stories. In this instance, the story may be obtained by summarizing events on the controversial subject at a predetermined point in time and presented with quotations of positive and negative opinion leaders.

An aspect may measure a positive ratio and a negative ratio with respect to a controversial subject and automatically output stories that show opinions of positive and negative opinion leaders in a latest order, thereby deriving a real survey result through a data analysis.

An aspect may collect news articles including a controversial subject or keyword, extract news information sources and quotations of the news information sources from the news articles, determine whether each of the quotations is positive or negative through a sentiment analysis, and estimate a positive and negative ratio with respect to the corresponding subject by counting a number of positive quotations and a number of negative quotations.

An aspect may collect news articles including a controversial subject or keyword, extract news information sources and quotations of the news information sources from the news articles, determine whether each of the quotations is positive or negative through a sentiment analysis, and when the news information sources are points or nodes and at least two news information sources are quoted in the same news article, connect points corresponding the news information sources using lines or edges to form a social network. A connection degree centrality or a betweenness centrality, which are of a social network analysis method, may be measured to quantitatively calculate an importance of a news information source and count a number of positive quotations and a number of negative quotations based on the importance, thereby estimating a positive and negative ratio with respect to the corresponding subject.

An aspect may measure a connection degree centrality or a betweenness centrality in a news information source network to identify news information sources corresponding to representative opinion leaders.

To detect events or stories about a controversial subject, an aspect may collet news articles including all nodes in an information source network corresponding the subject and output clusters including similar news articles using a hierarchical clustering method. In this instance, a similarity or distance-based method may be used to detect news articles having similar texts and detect news articles having close issue dates so as to be clustered.

According to an aspect, a story about a controversial subject may include \textcircled{1} a title, \textcircled{2} a date, \textcircled{3} a neutral and representative sentence introducing the story, \textcircled{4} salient quotations and information sources of a positive group, and \textcircled{5} salient quotations and information sources of a negative group.

According to an aspect, an object function may be used to automatically detect a neutral and representative sentence introducing a story. The object function may be implemented based on \textcircled{1} fact information, \textcircled{2} a similarity between a title and a text of a news article, and \textcircled{3} sentence location information. The fact information may be obtained based on, for example, a place, an institution, a date, a percentage, a number, and a neutral sentiment score. The similarity between the title and the text may be measured based on a decree of a syntactic similarity, a degree of a semantic similarity, and a degree of a syntactic similarity based on location and date information. A location of a sentence in the news article may be quantitatively measured. An importance of terms of the object function may be automatically calculated using a deep learning method so as to be obtained as a weighted average. As a value of the object function increases, a more neutral and representative sentence may be obtained.

According to an aspect, when a keyword or subject related to a controversial subject is input and executed in a search engine using an application of the above-described method, stories corresponding to the subject may be outputted in the latest order.

According to an aspect, a core idea to derive data-based survey results may be to convert unstructured data into social networks, and then use a social network analysis scheme. A social network may be generated by using a news information source network in a case of a news article and by connecting points corresponding to comment creators of the same post in a case of a social media. Also, whether a comment is a positive or negative may be determined through a sentiment analysis.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1-10. (canceled)

11. A method of analyzing digital content, the method comprising the steps of:
receiving a keyword corresponding to a predetermined subject;
collecting digital content associated with the subject based on the keyword;
extracting, from the digital content, a plurality of opinions related to the subject and a plurality of information sources providing the plurality of opinions;
generating a network based on the plurality of information sources;
performing at least one of a quantitative analysis and a qualitative analysis on the subject based on the network; and
providing an analysis result.

12. The method of claim 11, wherein the extracting of the plurality of information sources step comprises:
extracting an information source from words adjacent to a predetermined punctuation mark when the digital content is a news article.

13. The method of claim 11, wherein the extracting of the plurality of information sources step comprises:
extracting a commenter creator as an information source when the digital content is content posted on a social network.

14. The method of claim 11, wherein the generating of the network step comprises:
configuring the extracted information sources as nodes; and
connecting nodes corresponding to information sources extracted from the same digital content.

15. The method of claim 11, wherein, to perform the quantitative analysis, the performing step comprises:
classifying polarities of the plurality of opinions into positive, neutral, and negative;
calculating weights of the plurality of information sources based on the network; and
calculating quantitative statistics of positive opinions and negative opinions about the subject based on a result of the classifying and the weights.

16. The method of claim 15, wherein the calculating of the quantitative statistics step comprises:
calculating, for each of the plurality of information sources, scores of the plurality of information sources based on a polarity of opinions of the corresponding information source and a weight of the corresponding information source; and
calculating the quantitative statics based on the scores of the plurality of information sources.

17. The method of claim 11, wherein, to perform the qualitative analysis, the performing step comprises:
detecting time-chronological main stories associated with the subject based on a plurality of subgraphs included in the network; and
extracting a representative sentence neutrally describing each of the main stories, a representative positive opinion about the subject, and a representative negative opinion about the subject.

18. The method of claim 17, wherein the extracting of the main stories step comprises:
collecting, for each of the subgraphs, digital content including at least one information source in the corresponding subgraph;
performing an unsupervised clustering on the digital content including the at least one information source based on a content similarity and a time similarity; and
determining each of clusters generated as a result of the clustering to be a main story.

19. The method of claim 17, wherein the extracting of the representative sentence step comprises:
selecting, for each of the main stories, latest digital content from digital contents included in the corresponding main story;
extracting the representative sentence from the latest digital content based on a first reference associated with a neutral sentence characteristic, a second reference associated with a sentence title similarity, and a third reference associated with a sentence location;
extracting a most influential information source having a positive polarity and a most influential information source having a negative polarity from information sources of the corresponding main story; and
extracting opinions of the extracted most influential information sources.

20. A non-transitory computer-readable medium comprising a program configured for instructing a computer to perform the method of claim 11.
